(19) United States
(12) Patent Application Publication
(10) Pub. No.: US 2005/0047149 A1
(43) Pub. Date: Mar. 3, 2005

(54) Lamp containment barrier

(76) Inventors: Aaron O'Brien, Munster, IN (US); Christopher T. Bobrowski, Chicago, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/652,591

(22) Filed: Aug. 29, 2003

(51) Int. Cl. F21V 11/00

(52) U.S. Cl. 362/355

(57) ABSTRACT

A lighting fixture with a containment barrier having a generally u-shaped cross sectional area and a housing is described. The housing forms a cavity and includes a light socket. The cavity has a covered portion that lies underneath the containment barrier and an exposed portion that does not lie underneath the containment barrier.

### FIELD OF THE INVENTION

This invention relates generally to lighting fixtures, and in particular, to a lamp containment barrier for covering a light bulb in a lighting fixture.

### BACKGROUND OF THE INVENTION

Lighting fixtures are plentiful in the art and well-known. Lamp containment barriers are also known in the art. Some types of existing lamp containment barriers envelope the light bulb within the lighting fixture. These would include tubes and plastic capsules which typically require removal of the light bulb from the lighting fixture in order for the tube or capsule to be installed. In addition to cumbersome installation, further drawbacks to these types of containment barriers include high operating temperatures, poorly designed optics, and bad aesthetics.

Other types of existing lamp containment barriers include flat sheets or lenses which completely cover the lighting fixture, and more particularly, a reflector in the lighting fixture. Drawbacks to these types of containment barriers include high operating temperatures resulting from the fact that the flat sheet or lens completely covers the reflector, not allowing for any air to circulate in and around areas surrounding the light bulb. The resulting poor circulating causes the temperature of the areas surrounding the light bulb to increase.

Accordingly, it would be desirable to provide a lamp containment barrier that can be installed easily without removal of any light bulbs in a lighting fixture, that allows for lower operating temperatures than the existing lamp containment barriers, and that does not greatly impede the optical performance of a lighting fixture.

### SUMMARY OF THE INVENTION

According to one aspect of the present invention a lighting fixture is provided. The lighting fixture comprises a containment barrier having a generally u-shaped cross sectional area. The containment barrier includes a top surface connected to first and second side surfaces and forms an opening between the first and second side surfaces. The lighting fixture also includes a housing with a reflector and a light socket. The reflector has a covered portion that lies underneath the containment barrier and an exposed portion that does not lie underneath the containment barrier. The first and second side surfaces both extend away from the top surface so that a cross-sectional area of the containment barrier is generally u-shaped.

According to another aspect of the present invention, a lighting fixture is provided. The lighting fixture includes a containment barrier having a generally u-shaped cross sectional area and a housing. The housing forms a cavity and includes a light socket. The cavity has a covered portion that lies underneath the containment barrier and an exposed portion that does not lie underneath the containment barrier.

According to another aspect of the present invention, a containment barrier for covering only a portion of a cavity formed by a housing is provided. The housing includes a light socket for receiving a light bulb. The containment barrier includes a top surface having opposing first and second ends, a first side surface connected to the first end, and a second side surface connected to the second end, wherein the first and second side surfaces extend towards so that the cross-sectional area of the containment barrier is generally u-shaped.

Other features and advantages of the present invention will be set forth, in part, in the descriptions which follow and the accompanying drawings, wherein the preferred embodiments of the present invention are described and shown, and, in part, will become apparent to those skilled in the art upon examination of the following detailed description taken in conjunction with the accompanying drawings, or may be learned by practice of the present invention. The advantages of the present invention may be realized and attained by means of instrumentalities and combinations particularly pointed out in the appended claims.

### BRIEF DESCRIPTION OF THE DRAWINGS

FIG. 1 is a perspective view of a lamp containment barrier, in accordance with one embodiment;

FIG. 2 is a cross sectional view of the lamp containment barrier shown in FIG. 1 taken along lines 2-2, in accordance with one embodiment;

FIG. 3 is a perspective view of a lighting fixture with a lamp containment barrier, in accordance with one embodiment;

FIG. 4 is a partial perspective view of a lighting fixture with a lamp containment barrier, in accordance with one embodiment;

FIG. 5 is a partial perspective view of a lighting fixture with a lamp containment barrier, in accordance with one embodiment;

FIG. 6 is a cross sectional view of the lamp containment barrier shown in FIG. 3 taken along lines 6-6, in accordance with one embodiment;

It should be appreciated that for simplicity and clarity illustration, elements shown in the figures have not necessarily been drawn to scale. For example, the dimensions of some of the elements are exaggerated relative to each other for clarity. Further, where considered appropriate, reference numerals have been repeated among the figures to indicate corresponding elements.

### DETAILED DESCRIPTION OF THE PREFERRED EMBODIMENTS

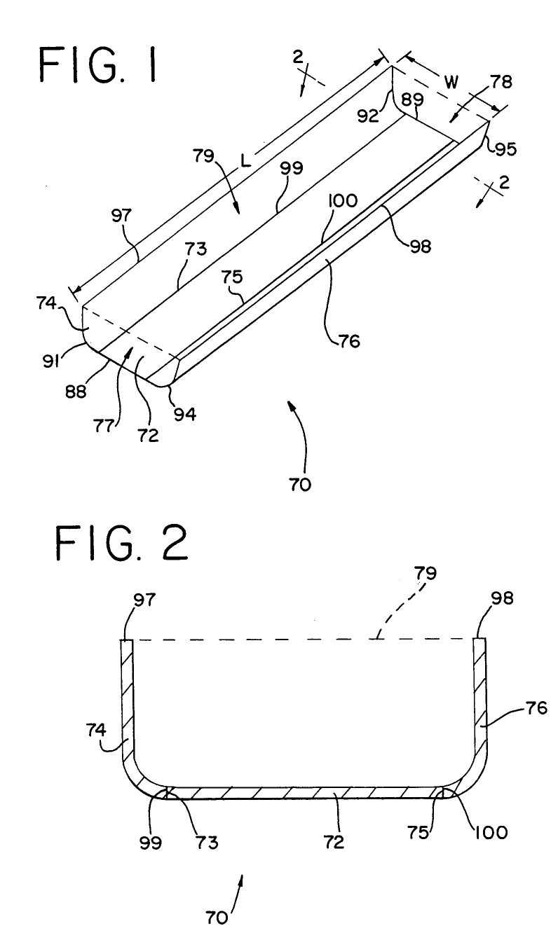

FIG. 1 illustrates a lamp containment barrier 70 for covering a cavity formed by a housing of a lighting fixture. The lamp containment barrier 70 includes a top surface 72, and a first side surface 74 opposed to a second side surface 75, as illustrated in FIGS. 1 and 2. Preferably, the top surface 72 and the side surfaces 74 are all formed from at least one if not a plurality of sheets of material. Preferably, the material is a translucent material, and more preferably, the material is a transparent material, such as a polymer, a silicon-based material such as glass, or a crystalline substance. In one embodiment, the material that the top surface 72 and the side surfaces 74 are all formed from is moderately rigid so that it may hold its own form. In one embodiment, the top surface 72, the first side surface 74, and the second side surface 76 are separately formed and then later connected to each other. In one embodiment, the top surface 72, the first side surface 74, and the second side surface 76 are all integrally formed as one piece.

In one embodiment, the top surface 72 is generally flat, as illustrated in FIG. 1. However, the top surface 72 may also be curved so as to generally conform to the shape of a light bulb or light bulbs that is to be received by a light socket 62 of the housing 24, of which the containment barrier 70 is designed to cover. As used herein, the term “generally conform” does not require that the shape of the lamp containment barrier to be exactly the shape of the lamp itself. By generally conforming to the shape of a light bulb, portions of the lamp containment barrier 70, such as top surface 72, or side surfaces 74 and 76, retain some of the original optics of a light bulb installed within the lighting fixture 20. The top surface 72 is includes a first end 73 opposed to a second end 75 and a first edge 88 opposed to a second edges 89, as illustrated in FIG. 1.

The first side surface 74 includes a first edge 91 opposed to a second edge 92 and a free end 97 opposed to a connected end 99. The second side surface includes a first edge 94 opposed to a second edge 95 and a free end 98 opposed to a connected end 100. The connected end 99 of the first side surface 74 is connected with the first end 73 of the top surface 72, while the connected end 100 of the second side surface is connected with the second end 75 of the top surface 72, as illustrated in FIGS. 1 and 2. First and second side surfaces 74, 76 both extend in a direction that is generally away from the top surface 72. Additionally, first and second side surfaces 74, 76 both extend in the same direction, as illustrated in FIGS. 1 and 2. In one embodiment, the first and second side surfaces 74, 76 extend in a direction that is generally perpendicular to the general direction of the top surface 72, as illustrated in FIG. 2. Preferably the first and second side surfaces 74, 76 are curved, as illustrated in FIG. 2. However, the first and second side surfaces 74, 76 may take on other shapes, such as being generally straight. In one embodiment, the first and second side surfaces 74, 76 are curved so as to conform to the shape of light bulb or light bulbs of which the containment barrier 70 is designed to cover, in order to retain some of the original optics of the light bulb or light bulbs of which the containment barrier 70 is designed to cover.

The lamp containment barrier 70 has a developed width W that is defined herein as the distance between the two free ends 97, 98. Additionally, the lamp containment barrier 70 has a developed length L that is defined herein as the distance between the first and second edges 88, 89 of the top surface 72. Preferably, the length L of the lamp containment barrier 70 is greater than the width W of the lamp containment barrier 70. In one embodiment, the length L of the lamp containment barrier 70 is more than twice the width W of the lamp containment barrier 70.

By connecting the first and second side surfaces 74, 76 to the top surface 72, as described above, the lamp containment barrier 70 employs a generally u-shaped cross section. The u-shaped cross sectional area of the lamp containment barrier 70, as defined herein, a cross-sectional area of the lamp containment barrier 70 which is taken in a direction from the free end 97 to the free end 98, as illustrated in FIG. 2. The lamp containment barrier 70 also forms three openings which allow the lamp containment barrier 70 to be easily removed from the lighting fixture without having to remove a light bulb. A first opening 77 is formed between the first edge 91, the first edge 88, and the first edge 94, as illustrated in FIG. 1. A second opening 78 is formed between the second edge 92, the second edge 89, and the second edge 95. While a third opening 79 is formed between the free end 97 and the free end 98.

By having a u-shaped cross sectional area, and additionally, by forming three openings 77, 78, and 79, the lamp containment barrier 70 of the present invention can be easily installed and removed from a lighting fixture without the removal of the light bulbs that may be attached to the lighting fixture. The containment barrier 70 is designed to contain accidental breakage or lamp envelope eruption of a light bulb. Applications in which a containment barrier is desirable, include, but are not limited to, restaurants, service counters, and medical areas such as examining rooms.

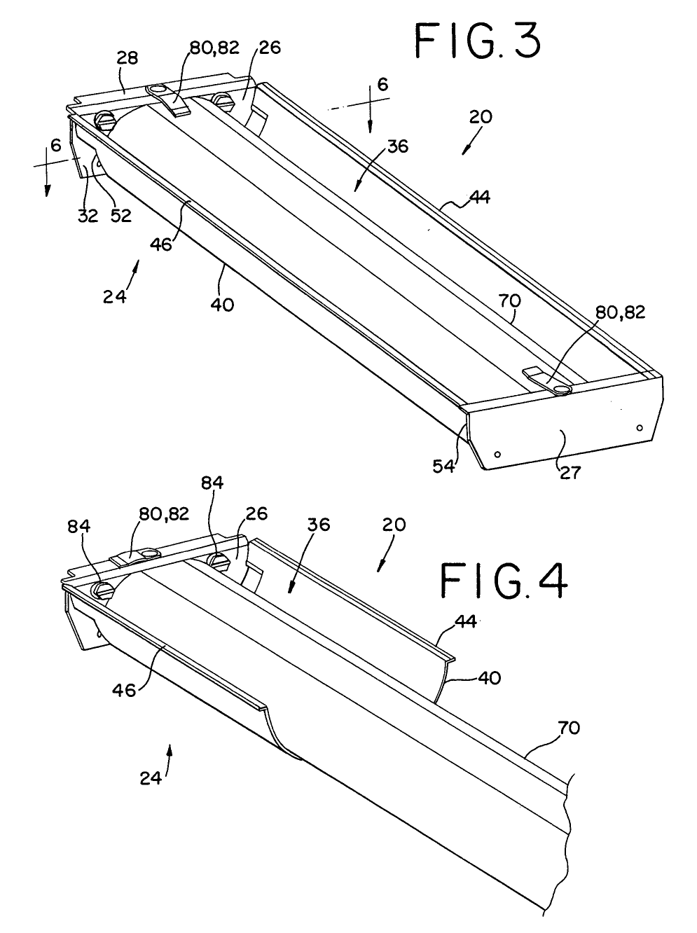

In one embodiment, the lamp containment barrier 70 is included with a lighting fixture 20, as illustrated in FIGS. 3-6. In addition to including the lamp containment barrier 70, the lighting fixture 20 also includes a housing 24. The housing 24 forms a cavity 36 for inserting and maintaining a light bulb 60. The cavity 36 surrounds the light bulb 60 at at least one side, and preferably, at at least three sides, as illustrated in FIG. 3. The light bulb 60 may be any type of light bulb that generates light. In one embodiment, the light bulb 60 is a fluorescent light bulb, such as the JUNO T5HO Fluorescent series luminaries, manufactured by Juno Lighting in Des Plaines, Ill.

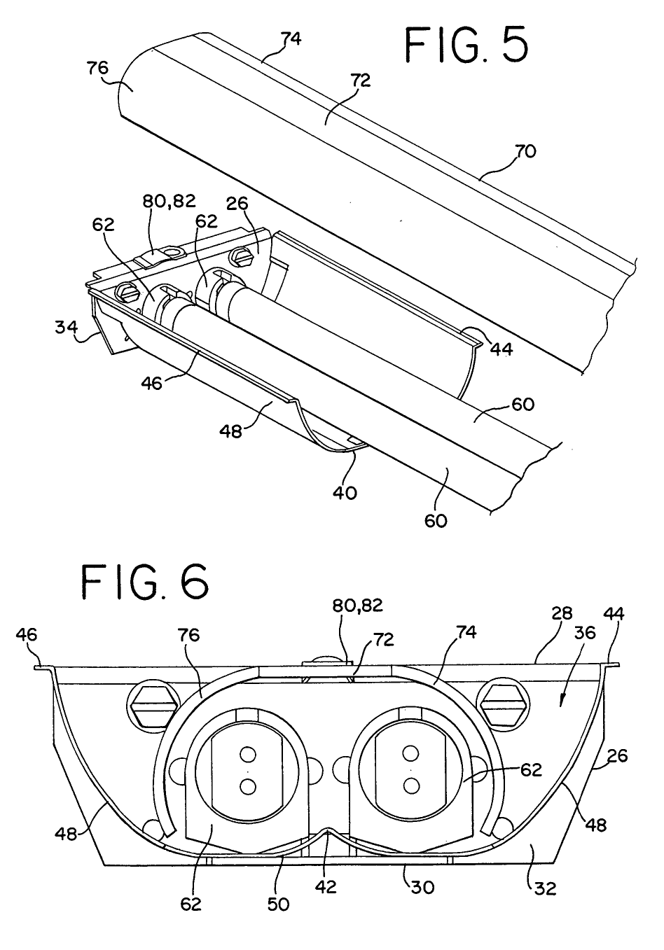

In one embodiment, the housing 24 includes a reflector 40 which forms at least a portion of the cavity 36, as illustrated in FIG. 3. Preferably, the reflector 40 includes an exposed portion 48 connected to a covered portion 50. As defined herein, the exposed portion 48 of the reflector 40 is a portion of the reflector 40 which is not covered by the containment barrier 70, once the containment barrier 70 is attached to the housing 24, as illustrated in FIG. 6. Preferably, the surface of the reflector 40 is curved so as to generally conform to the shape of the light bulb 60 or light bulbs 60 that are to be received by the housing 24. In one embodiment, the reflector 40 forms a lip 42, as illustrated in FIG. 6. Preferably, the lip 42 is formed between a pair of light bulbs 60, so as to generally conform to the shape of the light bulbs 60. Preferably, the reflector 40 is located beneath a light socket 62 of the housing 24 and is designed to reflect light that is emitted from a light bulb 60 inserted into the light socket 62. Preferably, the reflector 40 comprises a conductive material, such as a metal. However, the reflector 40 may comprise any type of material which may be used to reflect at least a portion of light from the light bulb 60, such as a polymer and other non-conductive materials. In one embodiment, the reflector 40 has a polished finish in order to reflect a greater portion of light from the light bulb 60. The reflector 40 includes a first edge 44 opposed to a second edge 46. Preferably, the first and second edges 44, 46 are both at opposing ends of exposed portions 48, as illustrated in FIG. 6. The containment barrier 70 is located between and not connected to first and second edges 44, 46 when attached to the housing 24, as illustrated in FIGS. 3 and 6.

In one embodiment, the reflector 40 is sandwiched in between a pair of opposing end portions 26, 27 in order to form the cavity 36, as illustrated in FIG. 3. Each end portion 26, 27 includes a top side 28 opposed to a bottom side 30, and a back side 30 opposed to a front side 32. Opposing end 52, 54 of the reflector 40 are connected with the front side 32 of each end portion 26, 27. Fasteners, such as screws 84, may be used to fasten each end 52, 54 of the reflector 40 to the front side 32 of each end portion 26, 27.

In one embodiment, the housing 24 includes at least one fastener 80 for removably or fixedly securing the containment barrier 70 to the housing 24. Preferably, the containment barrier 70 is removably connected to the housing 24 using the fastener 80. The fastener 80 may include any type of fastening mechanism, such as a mechanical type fasteners including a snap fit type fastener, VELCRO™, nails, screws, and clips, such clip 82; and chemical type fasteners such as glue or tape.

In one embodiment, the housing includes at least one light socket 62 for receiving and securing the light bulb 60. The light socket 62 may be connected to any portion of the housing 24, such as the reflector 40. Preferably, the light socket 62 is located within the cavity 36. In one embodiment, the light socket 62 is connected to at least one end portion 26, 27 of the housing 24. In one embodiment, the light socket 62 is connected to the front side 32 of one end portion 26, 27, as illustrated in FIG. 5. In one embodiment, at least two light sockets 62 are connected to each end portion 26, 27 of the housing 24. The light socket 62 can receive and secure the light bulb 60. Preferably, the light socket 62 is also able to provide power to the light bulb 60.

In operation, the containment barrier 70 may be removed from the housing 24 if the fasteners 80 are removably connected to the containment barrier, as illustrated in FIGS. 3-5. In this embodiment, fasteners 80, such as clips 82, are released from the containment barrier 70, as shown in FIG. 4, and the containment barrier 70 is then lifted away from the reflector 40, as illustrated in FIG. 5. By forming three openings 77, 78, and 79, the containment barrier 70 may be removed from the housing 24 without having to remove the light bulbs 60. Additionally, by forming a u-shaped cross-section, the containment barrier 70 is able to rest over only a portion of the reflector 40, allowing for the exposed portion 48 of the reflector 40 to come into contact with circulating air that is not enclosed by the containment barrier 70. By allowing for the exposed portion 48 to come into contact with circulating air, the overall temperature of the lighting fixture 20 may be reduced.

Since certain changes may be made in the above apparatus without departing from the scope of the invention herein involved, it is intended that all contained in the above description as shown in the accompanying drawings, shall be interpreted as an illustrative, and not a limiting sense. It is not intended that the invention be limiting sense. It is not intended that the invention be limited to the illustrative embodiments.

1. A lighting fixture comprising:
a containment barrier having a generally u-shaped cross sectional area, the containment barrier including a top surface connected to first and second side surfaces, wherein the containment barrier forms an opening between the first and second side surfaces; and
a housing including a reflector and a light socket, the reflector having a covered portion that lies underneath the containment barrier and an exposed portion that does not lie underneath the containment barrier, wherein the first and second side surfaces extend towards the reflector.

2. The lighting fixture of claim 1, wherein the containment barrier is removably connected to the housing.

3. The lighting fixture of claim 1, wherein a portion of the first side surface generally conforms to the shape of the light bulb that is to be received in the light socket.

4. The lighting fixture of claim 1, wherein the housing includes a pair of opposing end portions each connected to an end of the reflector.

5. The lighting fixture of claim 1, wherein the containment barrier comprises a polymer.

6. The lighting fixture of claim 1, wherein the containment barrier is translucent.

7. The lighting fixture of claim 6, wherein the containment barrier is transparent.

8. The lighting fixture of claim 1, wherein the housing includes a fastener, and wherein the fastener is removably connected with the containment barrier.

9. The lighting fixture of claim 1, wherein the reflector comprises a conductive material.

10. A lighting fixture comprising:
a containment barrier having a generally u-shaped cross sectional area; and
a housing forming a cavity and including a light socket, the cavity having a covered portion that lies underneath the containment barrier and an exposed portion that does not lie underneath the containment barrier.

11. The lighting fixture of claim 10, wherein the containment barrier is removably connected to the housing.

12. The lighting fixture of claim 10, wherein the containment barrier includes a first side surface opposed to a second side surface, wherein the first and second side surfaces extend toward and cover a portion of the cavity.

13. The lighting fixture of claim 12, wherein a portion of the first side surface conforms to the general shape of a light bulb that is to be received in the light socket.

14. The lighting fixture of claim 10, wherein the housing includes a reflector and a pair of opposing end portions connected to opposing ends of the reflector, and wherein the reflector and the pair of opposing end portions form the cavity.

15. The lighting fixture of claim 10, wherein the containment barrier is translucent.

16. A containment barrier for covering only a portion of a cavity formed by a housing for a lighting fixture, comprising:
a top surface having opposing first and second ends;
a first side surface connected to the first end; and
a second side surface connected to the second end, wherein the first and second side surfaces both extend away from the top surface so that a cross-sectional area of the containment barrier is generally u-shaped.

17. The containment barrier of claim 16, wherein a portion of the top surface generally conforms to the shape of the light bulb that is to be received in the light socket.

18. The containment barrier of claim 16, wherein the top surface, the first side surface, and the second side surface are all translucent.

19. The containment barrier of claim 16, wherein the top surface, the first side surface, and the second side surface comprise a polymer.

20. The containment barrier of claim 16, wherein the top, first side, and second side surfaces each have first and second opposing edges, the first and second side surfaces each have first and second free ends not connected to the first and second ends of the top surface, the first edges form a first opening, the second edges form a second opening, and a third opening is formed between the free ends.
